(19) United States
(12) Patent Application Publication
(10) Pub. No.: US 2020/0052924 A1
(43) Pub. Date: Feb. 13, 2020

(54) WIRELESS OUTDOOR CONTROL PANEL

(71) Applicant: SIMPLIFI'D OUTDOOR SOLUTIONS, L.L.C., Mesa, AZ (US)

(72) Inventors: Eduardo Daniel Gimeno, Mesa, AZ (US); Kristopher Michael Robinson, San Tan Valley, AZ (US)

(73) Assignee: SIMPLIFI'D OUTDOOR SOLUTIONS, L.L.C., Mesa, AZ (US)

(21) Appl. No.: 16/357,164

(22) Filed: Mar. 18, 2019

Related U.S. Application Data
(60) Provisional application No. 62/644,262, filed on Mar. 16, 2018.

(51) Int. Cl. H04L 12/28

(52) U.S. Cl. CPC H04L 12/2818; G06F 3/04847; H04L 2012/2841

(57) ABSTRACT

A complete backyard control solution accessible from anywhere in the world via the Internet or other network. Control and set schedules for a multitude of relays, varying voltages control 12, 24, 110 and 220 volt devices from the palm of your hand. Webpage access does not require any special apps. Open your web browser, login to your account and have access to any and all of your available features. Install a wide array of sensors and set programming options to depend on the values of the sensors. Install a remote sensor and never have to worry about manual missteps.

### CLAIM OF PRIORITY

The present application includes subject matter disclosed in and claims priority to a provisional application entitled “Simplified Outdoor Solutions Panel” filed Mar. 16.2018 and assigned Ser. No. 62/644,262, which application is herein incorporated by reference.

### BACKGROUND OF THE INVENTION

### 1. Field of the Invention

The present invention relates generally to control of automated power systems. The present invention more particularly relates to a single control unit receiving and sending and powering multiple analog and digital components.

### 2. Description of Related Prior Art

Conventionally, numerous onsite, backyard, facilities, or other settings included numerous automated components to manage varied equipment and appliances. Bach of these appliances would require a power source specific in both voltage and amperage to the equipment and/or appliance, as well as scheduling and control settings over operation. In the past, automated equipment has been controlled, and sometimes selectively powered, by remote automated control systems. For instance, in managing a water pool system, one or more sensors may be arrayed along the pump and piping system to determine the status of the pump and automated cleaning systems. Depending on feedback of the sensors, adjustment to the system protocol may be made automatically by a remote controller. Such remote controller may either initiate power, or otherwise supply such power, to the pump system. Furthermore, other systems such as lighting, irrigation, etc., have utilized similar automated control systems.

Many of these facility control systems included separable software and power supplies due to the varied nature of power and control needs Attempts have been made to integrate software to control each of the systems. However, due to the varied nature of power requirements, digital and analog signaling, etc., a complete solution has yet to be envisioned. Furthermore, due to the varied and unrelated nature of many of these components, little to no effort has been expended in providing a one piece solution to this problem.

Therefore, it is a primary object of the present invention to provide a single control system to receive and execute commands to a variety of systems.

It is a further object of the present invention to provide a singular power source providing a multitude of power types to power one or more of a variety of remote systems.

It is a further object of the present invention to provide a variable control system allowing for programming and modification of operation settings for a variety of systems.

These and other objects of the present invention will become apparent to those skilled in the art as the description thereof proceeds.

### SUMMARY OF THE INVENTION

The present invention is directed to a control panel system. The control may provide monitoring, reporting, and controlling of a multitude of systems via a computerized and electronic system, preferably with an on board local processor. The control panel is set within a housing enclosing a main processor, relays, signal receivers, and signal conveners adapted to receive, and transform analog signal to digital for use in the local main processor. The main processor utilizes software to instruct remote systems that are electronically coupled to the panel. The remote systems include one or more of the systems found on a facility, including, but not limited to such systems as irrigation, electrical, security, pool, heating, misting, and landscaping, irrigation, or similarly situated remote systems that may be used in a yard, or other facility as discussed below or as known in the art for management at a location.

The panel may be connected to a network system in communication with main processor, to allow the main processor to send and receive signals from a remote server. Alternatively, or in addition, the panel may be connected to a local GUI user input control system. The network communication sub-system may establish a network connection between the main processor and at least one remote system, such as remote systems requiring 12V to 220V AC and DC power, and otherwise as is known in the art. The sub-system may allow for remote monitoring of operational parameters associated with the remote system. The system handles signals in both analog and digital formats. The sub-system may provide remote control of the remote system from the main processor over the network subsystem connection.

The main processor may also be coupled to a wireless adapter within or on the panel allowing the main processor to send outgoing wireless signals to an outboard computer, such as a remote server. The outgoing wireless signals include information regarding the status of the remote systems, as well as processor-generated past events (from processor memory or buffering system, or otherwise), and processor-generated (or memory stored) schedule for future events (powering, controlling, or otherwise). Preferably, the wireless adapter may receive incoming wireless signals and transmit to the main processor. The main processor may store the incoming signal in temporary memory or translate and store same. The main processor may then modify its generated schedule for future events based on said incoming wireless signals. The incoming wireless signals may include software upgrades to load into main processor memory, shut down and restart main processor to update the main processor software.

The control panel of the present invention may receive an alternating current power, and transformers to provide both alternating current and direct current to said remote systems via a system of power supplies, each of said power supplies directed to one or more of said remote systems to power and control said remote systems. This power supply may be accompanied by a digital and/or analog signal to said remote system; said digital and/or analog signal provided along with said power supply.

The control power supply may be convened to 12-V direct current via a 12 VDC transformer. The control panel may use a 5 VDC transformer adapted to convert processed 12-volt direct current to 5-volt direct current to provide power to run the main processor. The control panel may use a transformer to modify incoming voltage to a new useful outgoing voltage for supply to a remote system. The control panel may use a grounded 125-volt GFCI with automatic internal testing as a power source for the control panel and all remote systems. The GFCI may be rated for 85 to 125V. The GFCI may detect trips on actual ground faults during or self-testing.

The control panel may use a multi-pinned high-voltage relay to receive low voltage power, transform and provide high-voltage for managing high voltage power supplies when needed at a remote system. A low-voltage relay board may be equipped with a high-current relay up to 12V. The main processor may be a Raspberry Pi with preloaded software, most preferably a Pi 3 Model B. The Raspberry Pi should be able to compute a preprogrammed software algorithm based on an incoming analog signal from a remote system. Multiple systems may provide analog signals, such as a soil moisture sensor, a vacuum sensor, a pressure sensor, an oxidation reduction potential sensor, a pH sensor, a total-dissolved-solids sensor. When referring to the local processor, the Raspberry Pi (and its structure, functionality) is intended.

The Raspberry Pi should be able to compute a preprogrammed software algorithm based on an incoming digital signal from a remote system. Multiple systems may provide digital signals, such as a temperature sensor, etc.

The present invention also includes a method for remotely monitoring and controlling at least one remote system via the Internet or other greater network. First the system assigns a location of a remote system in a local processor. The processor establishes a network connection between the remote processor or a remote server and the local processor. The system allows remote monitoring of operational parameters associated with the remote system from the local processor over the network connection. The system allows for remote control of the remote system from the local processor over the network connection. The local processor should be coupled to at least one control board to provide signals to control both the remote system and power supply. The system may power remote systems in both AC and DC power, and may handle incoming signals in both digital and analog.

The local processor may run a software program to manage more than one remote system in at least two separate programming languages, such as Pentair and Hayward, or otherwise. For each remote device, the local processor should determine whether line power is being supplied to a remote system. The local processor should also calculate a programmed schedule of managing a remote system, and provide power and input to the remote system to activate the remote system according to the preprogrammed algorithm.

The local processor may include a local clock, or rely on the remote server for the clock. The local processor should also be able to receive operational data from a remote system sensor and determine, based on the incoming data, if further action is required. The local processor then may take necessary action of turning on, turning off, or modifying the rate of power supply, or provide input commands to a processor on the remote device/system. The local processor may send a signal via a wireless transmitter to a remote processor, the signal including information from a multitude of sensors from a multitude of remote systems, and the remote processor displaying the information in a graphical user interface for the user's review. The user may then modify a programmed schedule, and transmit commands through the remote server or directly via local GUI; back to the local processor, to allow the local processor to amend the programmed schedule in accordance to commands received originating from user.

### BRIEF DESCRIPTION OF THE DRAWINGS The present invention wall be described with greater specificity and clarity with reference to the following drawings, in which:

FIG. 1 illustrates an interior layout of a load center with a main breaker connection of an embodiment of the present invention.

FIG. 2 illustrates tire interior layout of a load center with 12 VDC transformer connection of the embodiment shown in FIG. 1.

FIG. 3 illustrates the interior layout of a load center with 12V device to low voltage relays of the embodiment shown in FIG. 1.

FIG. 4 illustrates the interior layout of a load center with 24 VAC device to low voltage relays of the embodiment shown in FIG. 1.

FIG. 5 illustrates the interior layout of a load center with 24 VAC transformer connection of the embodiment shown in FIG. 1.

FIG. 6 illustrates the interior layout of a load center with 110V appliance to high voltage relay connection of the embodiment shown in FIG. 1.

FIG. 7 illustrates the interior layout of a load center with 220V appliance to high voltage relay connection of the embodiment shown in FIG. 1.

FIG. 8 illustrates the interior layout of a load center with analog sensor connection of the embodiment shown in FIG. 1.

FIG. 9 illustrates the interior layout of a load center with digital sensor connection of the embodiment shown in FIG. 1.

FIG. 10 illustrates the interior layout of a load center with high voltage relay to low voltage relay connection of the embodiment shown in FIG. 1.

FIG. 11 illustrates the interior layout of a load center with printed circuit board to low voltage relay board connection of the embodiment shown in FIG. 1.

FIG. 12 illustrates the interior layout of a load center with local processor R-pi CPU to 12V Transformer connection of the embodiment shown in FIG. 1.

FIG. 13 illustrates a network schematic diagram of an embodiment of the present invention.

FIG. 14 demonstrates a webpage interface of an embodiment of the present invention.

FIG. 15 demonstrates a webpage interface of an embodiment of the present invention.

FIG. 16 demonstrates a webpage interface of an embodiment of the present invention.

FIG. 17 demonstrates a webpage interface of an embodiment of the present invention.

FIG. 18 demonstrates a webpage interface of an embodiment of the present invention.

FIG. 19 demonstrates a webpage interface of an embodiment of the present invention.

FIG. 20 demonstrates a webpage interface of an embodiment of the present invention.

FIG. 21 demonstrates a webpage interface of an embodiment of the present invention.

FIG. 22 demonstrates a webpage interface of an embodiment of the present invention.

FIG. 23 demonstrates a local system with panel and remote systems of an alternative embodiment of the present invention.

### DETAILED DESCRIPTION OF THE PREFERRED EMBODIMENTS

The present invention allows for an Internet-of-Things outdoor control panel that provides control and connectivity to home-based systems. The present invention includes a complete systems-control solution supported by remote Webservers for access via the Internet. Control, criteria, and/or set schedules may be set and modified for a multitude of relays in varying voltages and current types, including operating and preferentially powering DC and/or AC, 12- and 24-volt, and 110- and 220-volt devices from a graphical user interface (GUI) through an Internet network to control a local processor to remotely control and selectively power remote systems, such as in a backyard, or a physical location.

The system status may be accessed, and the system may be controlled via GUI including a webpage accessible via an Internet web browser. The system is secured by login to access, modify, and control any and all of the connected available features. On-site, a wide array of sensors may be monitored via the GUI. User can set programming options to automatically act depending on the values of read into the local processor by the sensors (i.e. based on preprogrammed set criteria). For instance, a soil moisture sensor may provide analog signal to the control panel, which is then converted to a digital signal by the local processor, when a specific (low) water/humidity threshold is read, then a preprogrammed signal is sent.

The local system includes a software-based rules-engine for excessive flexibility, including multiple criteria programmed into each remote subsystem. In one embodiment, a local panel command center may include an integrated 360 Watt low-voltage (12V) transformer, an integrated 24 VAC transformer, ten high voltage relays (110V or 220V), sixty-four customizable low voltage relays (inclusive of the ten used to control the high voltage relays), additional customizable relay groups, preferably a majority of sixteen analog sensor inputs, four digital sensor input channels (each channel supporting up to 256 devices, for a total of 1,016 total devices enabled). BNC Sensor Connections are provided, preferably for water (quality) sensors. The processor should be RS485 control capable and allow custom rules individual for each relay, including timer and scheduling functions. The local panel may include locally and remotely accessible memory to log sensor data (preferably up to 365 days locally, and indefinitely longer at a remote server). The panel preferably includes a two-hundred Amp subpanel w/12 breaker slots to handle power supplied to remote systems. The local panel command center may include built-in wireless (e.g. Wi-Fi, cellular, radio frequency, Bluetooth, etc.) to communicate from local processor to a remote server. Both upload from the local processor to the remote processor, and reverse, download to local processor are provided. Remote server is accessible, preferably by network or Internet to provide a webpage accessible from anywhere on the network, or connected to the Internet. More preferably, local processor creates, hosts, and populates remote user GUI, whereas remote server merely acts to provide network connection for GUI. Therefore, the system may allow for remote software updates to be directed from the remote server to one or more local processors connected to the remote server. When local processor maintains GUI, remote server serves a primary purpose of network connectivity, and “remote server” may simply be a router, as is known in the art. Remote server may also provide other functions, such as data logging, and access to provide remote backup and software push upgrades to local processors). The remote server may provide for custom notifications to the user responsible tor one or more local facilities to provide text and/or email, etc. notifications based on preprogrammed criteria, e.g. timing, set levels, sensor or system malfunction, etc. The local processor may be accesses on site via a touchscreen display.

The user may access a local panel, or load center, using any web browser on a supported platform. It is contemplated that a single load center w ill provide housing for a multitude of power supplies. Commonly referred to as a “breaker box”, a multitude of circuit breakers in a circuit can provide numerous power supplies to a variety of systems. An aspect of the present invention includes the application of a variety of power sources through a single power circuit box. It is preferred that the load center is built with a shielded copper bus bar. Such a load center provides for a rainproof outdoor cover and can accommodate a plug-on secondary surge arrestor. The load center can be directly tied to a power source, and may include a standard outlet plug, such as a GFCI standard outlet. It is contemplated that the system can provide in the range of 200 amperes via 12-20 separate power zones through the load center. Each of the zones may be rated for a specific voltage, amperage, etc.

The system preferably includes a double row screw terminal strip to provide for connections for power output. It is contemplated that the input voltage into the system be of a high voltage, such as alternating current 175 volts to 220 volts, however the system may accommodate a lower voltage of approximately 110 volts. The load center will include power transformation features including transformation from an alternating current to a direct current. A main transformer may include a 12 volt DC convertor to receive alternating current and provide direct current. The 12 volt direct current is then used to either power direct current subsystems coupled via wiring to the load center, or thereafter converted into alternative direct current voltage as may be necessary. Furthermore, a 5 volt DC transformer is preferably used to convert the 12 volt direct current into 5 volt direct current for operation of the onboard processor, and in some instances the onboard primed circuit board.

In one preferred embodiment, the load center may be powered by a single low voltage (80-125 volts ) supply of approximately 20 amperes. Similarly, alternating current supplied through the GFCI may be utilized for each of the coupled subsystems. GFCI may be set to protect against surges or shorts in one of the circuit(s), e.g. pool lights, etc.

Given the variety of subsystems that may be powered via the load center in this embodiment, both high voltage relays, and low voltage relays will be required.

The preferred processor may include a Raspberry Pi, particularly the 3 Model B series, to manage multiple software language protocols, and otherwise manage routing, scheduling, receiving both digital and analog signals, input and modification of empowering and signaling to off board remote subsystems. Local processor is preferably programmed with translator to allow management of similar type systems from a multitude of manufacturers (to manage remote systems of a multitude of varieties). One such example translator will allow R5485 adapters to utilize pool systems of more than one type of pool systems. Pool systems may utilize similar 6- or 8-bit commands structures, such as a two bit identifier, a four bit command/instruction, and a preferred two bit verify code. Local processor should be programmed to handle commands to multiple pool system languages. Local processor may be coupled to relay board via a standard general purpose input-output (GPIO) communication link. Alternatively, local processor connects through the printed circuit board (PCB) to relay board. In one embodiment, the PCB handles incoming signals from local processor, such as Raspberry PI, and thereafter splits the signal on the PCB for a variety of subsystems. When using digital signaling, the PCB allows multiple sensors and remote devices to communicate on a single (or dual) pin of the local processor by utilizing identifiers. Local processor can thereby handle incoming and outgoing signals for many remote dev ices via the single pin (or pin grouping). Therefore the PCB expands the utility of the local processor to manage a multitude of systems, and would not therefore be limited based on number of pins in the local processor (a.k.a. Raspberry Pi).

Preferably, the load system includes a wireless adaptor to allow communication from the load system through a network to a remote processor, such as a central server. The central server may be housed offsite, such as in a global headquarters. Each of the local processors may communicate to the central server. The central server provides for management of each of the local servers, and otherwise provides for the secure log-in for each local server and control over each local server thereby. The central server is therefore in communication with each local server and allows for communication and software upgrades of local servers without interference with local server processing.

The local processor may run three concurrent individual parallel, and separable programs. This way, if one process fails, the remaining software program may be unaffected. The processor runs an operating system to handle power of processor, wireless adapter/transmitter, security access to processor applications, etc. The User Interface, including the web browser, and handling of scheduling, relay protocol rules, etc. are rung separately. In this manner, if a rule or signal or remote device causes a crash of the program, the operating system may still he accessible by remote administrator, such as to restart systems, etc. A third program includes a near duplicate UI running in parallel (on standby). On daily backups and or management from remote administrator or remote processor, the UIs toggle back and forth, each running on opposite alternating days. In this fashion, one may revert back one day should error accumulate on one UI or set of schemes. The operating system (OS) should be stored on a separate section of memory and run independently of UI systems. In case of UI corruption, the OS should remain unaffected. In addition, the OS may run separately to allow updates and connect via remote sever to diagnose issues in UI software. The remote server maintenance of a local processor may include turning local processor on/off, accessing operating system to get diagnostics, auto reboot, load a mirrored UI, or download from remote server backup to refresh local processor software.

Remote access may be made by encrypted signals and cause a cascade of events. Webpage and UI are hosted on the local processor. The remote server allow s for data backup and logging, and serves a primary function of allowing user to remotely access local processor. Remote server also may initiate daily backups of local processor, such as of UIs. Each day, the remote server may back up software from local processor including information such as all user settings, and change log, the UI, scheduling parameters, and possibly allow a reboot of one or more programs. The daily backup may also serve to toggle between the two UIs.

Each control panel may be outfitted with a wireless transmitter, such as a Wi-Fi adaptor, radio frequency, Bluetooth, broadband cellular network system, as may be known in the art. etc. or may be hardwired to another unit connected via the Internet to the central server. It is contemplated that a single remote central server may control via the Internet, a multitude of local processors coupled with each of the load centers so as to provide instructions, readouts, etc. accessible via the Internet. Each local processor hosts a webpage and set of pages, and may be connected to a remote server for access and data logging, etc.

Preferably, each load center is hardwired to a multitude of sensors detecting specific parameters of each coupled subsystem. Subsystems may include a pool pump, a waterfall, lighting, irrigation, etc. Incoming data into the load center is carried via hardwires (preferably) or may otherwise be wirelessly communicated to a receiver in the load center. Each of the signals can then be transmitted to the local processor and interpreted by the processor based on preconfigured software. The local processor may include automatic actions based on predetermined rules based on sensor input data. For instance, when a soil moisture sensor provides data from a garden subsystem to the local processor and includes information of a low soil moisture content, the local processor may initiate power to a valve system to open irrigation lines to provide water to the garden, and turn off when ideal moisture content attained.

Most of the sensors contemplated for the load center and local processor may arrive in the form of analog data (such as a voltage signal from 0-5 volts to send a voltage related analog signal). Analog data incoming from remote subsystems is preferably relayed through a circuit board and sent on to the local processor to convert analog signals into digital signals that can then be used by the local processor.

In order to meet varied schedules, the local processor may include, or more preferably may be coupled with a real-time clock/calendar. Alternatively, a remote signal may be provided by the remote central server or otherwise from a remote clock and calendar system, in order to provide timing for local processor to initiate varied predetermined schedules.

Each location may be outfitted with a number of remote subsystems. Each subsystem is coupled to the local load center. The load center includes a power supply that may be used to supply necessary power type to each of the subsystems. Power is supplied from the load system based on preprogrammed, or remotely programmed, protocols as computed at the local processor. Information from each of the sensors is relayed via the local processor through the (preferably) wireless communication to a network for communication with the central server. Remote access to information from each local processor, and thereby the information on all the subsystems at a specific location, may be accessed via a network, such as the Internet, to the through the network to the local server. Remote access is contemplated via a web browser type communication graphical user interface (GUI) hosted by local processor to allow a user to monitor and modify protocols at a specific location. In this way, a user may remotely monitor a variety of information of multiple subsystems at one or more locations from a remote access point.

Preferable remote systems powered and/or managed by the local processor include Aquatics/Ponds/Pools on the facility. For instance, the aquatics system would be coupled and powered by one of the high voltage relays in the panel's pool equipment control relay. The local processor may utilize RS485 communication protocols available for most major pool equipment and appliances. In addition, input data from digital and/or analog sensors on at the aquatics equipment may provide information to the local processor regarding pH, Chlorine. Salt, Temperature, and/or pressure readings (re: status of pump, filters, etc.). Such information can be relayed form local processor to the remote processor to make information accessible to user via network. The local processor may also be preprogrammed to relay and command peripheral controls based on sensor readings. Additional scheduling may be preprogrammed into the local processor to allow for control of variable speed pumps (often run 24/7) for filtering and cleaning system automation. Furthermore, the panel may include 24-Volt DC relays to control heaters, diversion valves, etc. for complete swimming pool automation. Local processor may be preprogrammed with safety rules to prevent damage to costly pool equipment, and initiate reactive and/or proactive alarms to notify user when sensor data exceed thresholds. Tins may be redundant, and should not be relied on for safety purposes in lieu of current safety systems on remote devices. Complete information and control may be provided to user over the network.

Other remote systems may include irrigation systems coupled to the panel. Preferably, 24 V DC relays can be used to power and control separable drip, lawn, plant and/or tree watering. Power may be used to open/close valves along a pressured water system, and/or to provide local pump pressure. The local processor may set individual schedules for each relay. For example, local processor may be programmed to locally process data from moisture sensors to determine over or under watering your lawn, plants or trees, and modify watering protocol accordingly. The local processor may be programmed remotely through the remote server, or locally via GUI interface, or simply bypass local processor to allow remote server to control and/or power a system directly. The system may include a GPS tied to the local processor to provide location data, or may otherwise be programmed for location information. The remote server may pull weather forecasts and send information along to local processor to allow automated modification of commands/rules at local processor, e.g. if rain in forecast, skip watering schedule for a day. Similarly, when temperatures drop below freezing or pressure in tubes increase dramatically, valves may open to prevent freezing water.

Low and high voltage lighting may also be similarly managed. Typical 12V DC relays can be used to take advantage of three hundred sixty watts of built-in low voltage power. Individual schedules can be set for each relay. Groups of relays can also be set to turn on or off from or back yard lights. In addition, remote server can allow user to access network to turn on/off the outdoor lights. In fact, any of the direct current (DC) 12V, and/or alternating current (AC) 24V, 110V or 220V relays may control any number of custom appliances or features. A small sample includes controlling firepots, mist pumps, string lights, LED lighting, BBQ's, fireplaces, fire channels. Additional sensors may include a water flow meter (gallons per minute, used to determine water usage/if there are any water leaks in irrigation/pools/etc.), ultrasonic sensor (used to determine pool/spa water level and control valves feeding water into pool/spa); flame sensor (used to monitor and control gas fire features), gas sensor (used to monitor and control gas fire features in case of leak), etc.

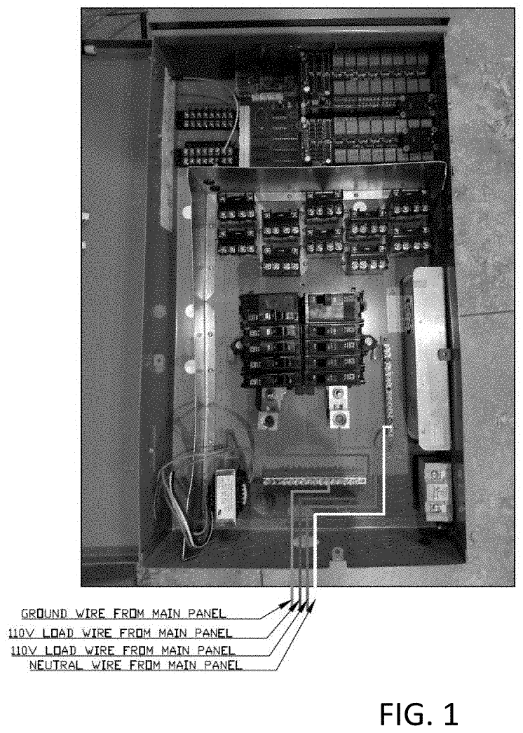

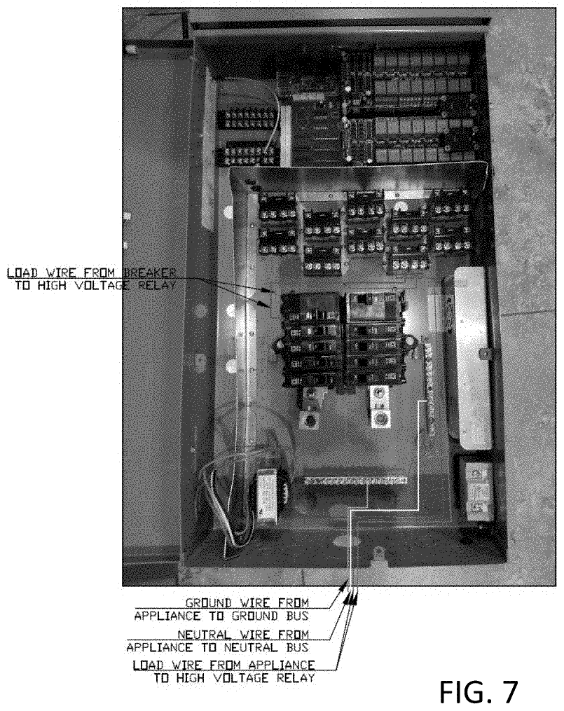

Referring now to the drawings, particularly FIGS. 1-12, the present invention includes a control panel set on a distribution board including multiple circuit breakers and an interchangeable circuit breaker arrangement. As seen in FIG. 1, power is supplied into control panel via inlet port 10 wherein a ground wire, a neutral wire, and 120 volt load wires in and out (providing 220-240 total volts), provide for powering of onboard features as well as powering the remote systems.

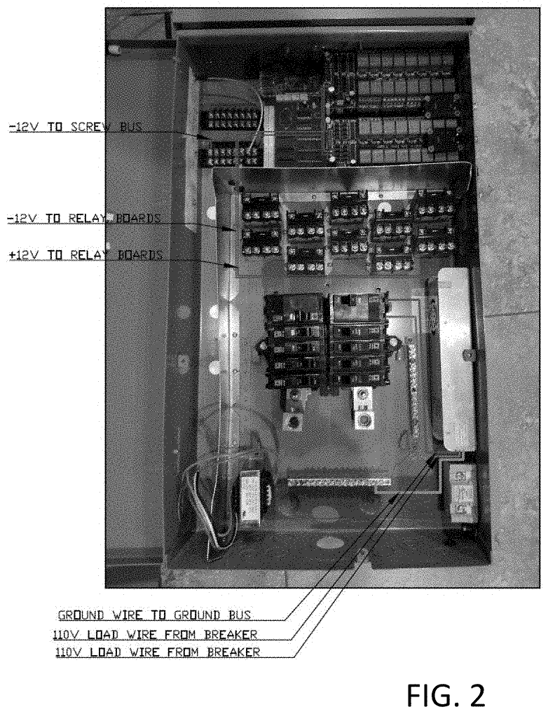

As seen in FIG. 2, 110 volt load wire from breaker provides the 12 volt transformer with power to the low voltage relay board and screw bus terminal. Screw bus terminal operates at 12 volts. A direct line from the 110 volt load is directed to one or more of the circuit breakers.

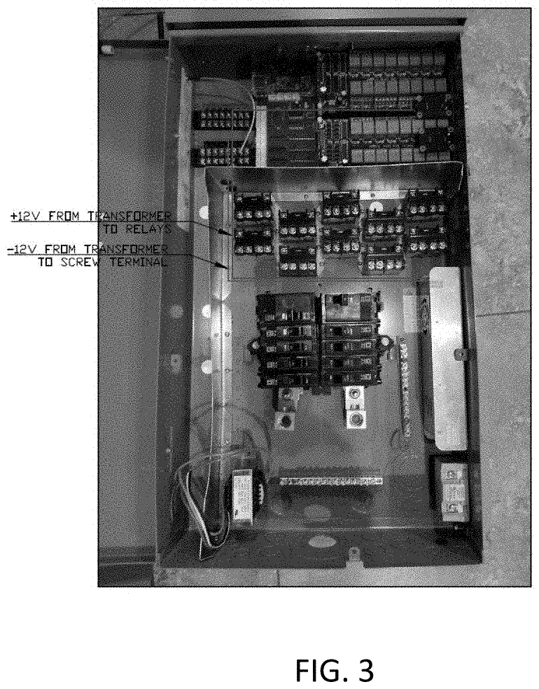

As seen in FIG. 3, 12 volt power is supplied from the 12 volt DC transformer connection to provide power to the low voltage systems. Power is intended to flow from inlet supply through transformer to the low voltage relays and thereon to the screw terminals. Power leaves relay board and exits panel to supply offboard remote systems. The circuit is continued wherein power cycle returning from remote systems is then grounded at control panel screw bus terminals. Alternatively, remote systems may ground at remote device(s). Additionally, 120 volt supply from breaker load center may be step-down transformed into a 24 volt of very low alternating current (e.g. for irrigation, pool, etc.). A wire may be used to direct power flow from relay board to a device, and the terminal bus may transfer power from the board to the device.

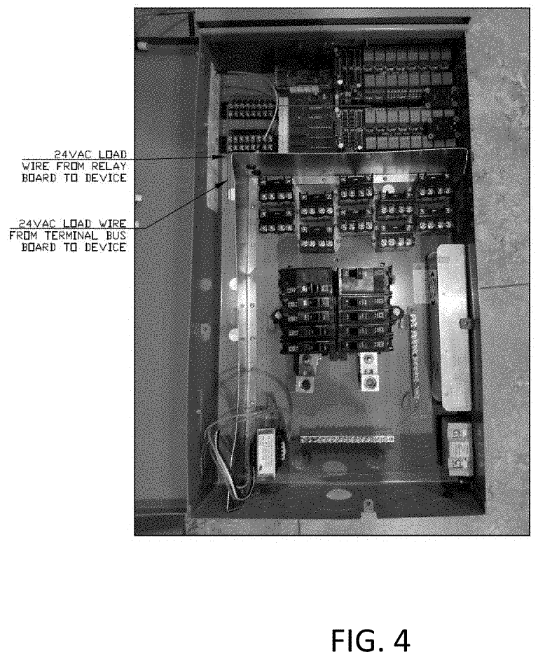

Referring now to FIG. 4, the 24-volt AC transformer connection is shown. 24-volt alternating current is provided to low voltage relays as shown, and return via screw bus. 120-volt AC load may be provided to the breaker, arid stepped down for use to power a remote system, and the circuit may be directed towards a neutral or ground.

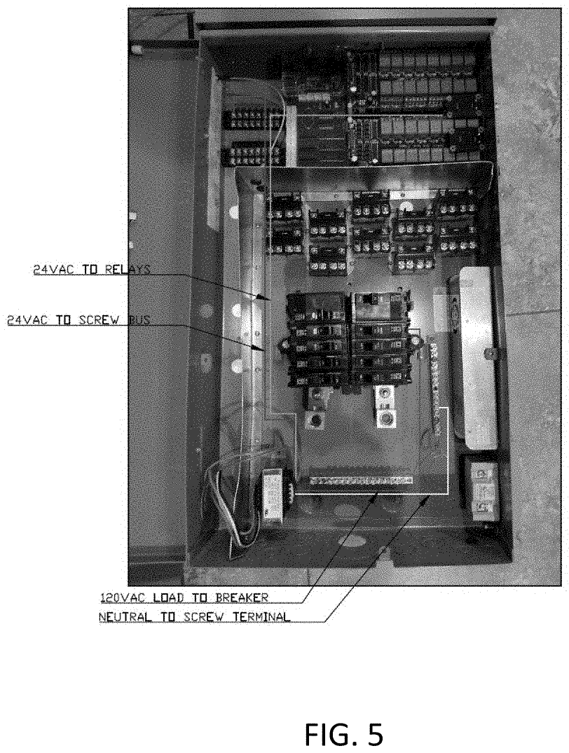

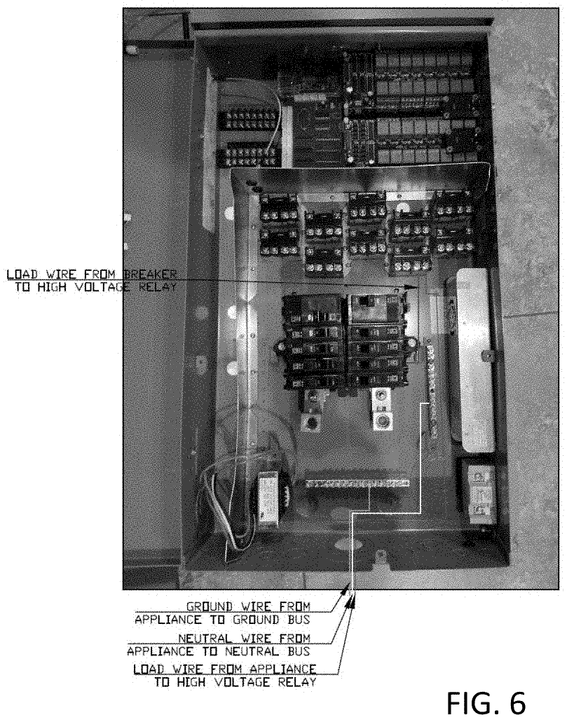

Referring now to FIG. 5, supply of 110 volts is preferred through inlet. However, when additional power requirements are made on the system and control panel, it is contemplated that a 220 alternating volt power supply may be used A load wire provides for power from appliance to neutral bus and therein transferred from neutral bus to ground. A load wire runs between the breaker system and the high voltage relay. Power is thereby supplied directly to high voltage relays and directed towards a breaker. The breaker sits along the circuit to various appliances. Similarly, as seen in FIGS. 6 and 7, 110 volt power supply may be provided through the high voltage relays and transformed into a 220 volt power supply. The 220 volt power supply will then run through one of the circuits through a circuit breaker. The 220 volt power is then supplied to a remote appliance (e.g. pool pump, heat pump, etc.).

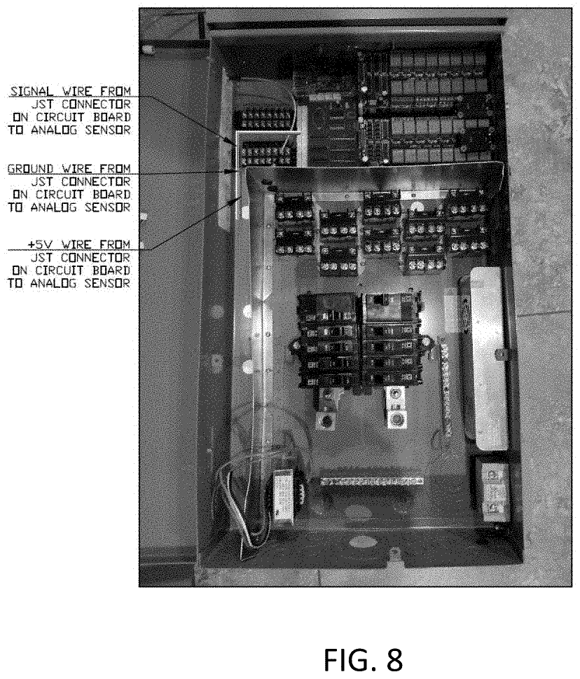

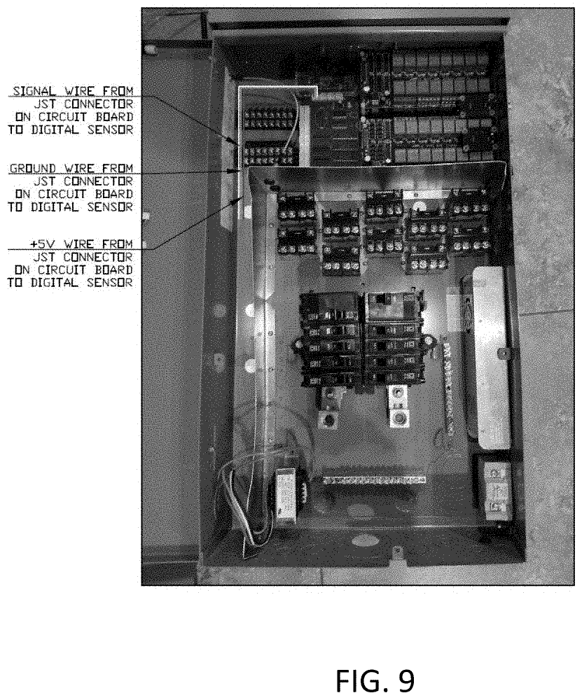

Referring now to the sensor array, as seen in FIG. 8, analog sensors may provide information from remote systems into control panel to reach the local processor. An incoming signal wire may be mounted via JST connector onto a circuit board to provide for data incoming from analog sensor. Transformation of analog signal preferably occurs in local processor. A ground wire from the JST connector on circuit board may also be required. The circuit board provides a five voltage power and signaling to the local processor. Local processor converts analog to digital utilizing a software encoded table. Each digital sensor can be addressed to allow a single JST to connect to local processor. Local processor sends signal with addressing to each digital sensor or remote device. As seen in FIG. 9, a similar circuit is formed, except utilizing the digital sensor array on the printed circuit board and relates to remote digital sensors at remote systems.

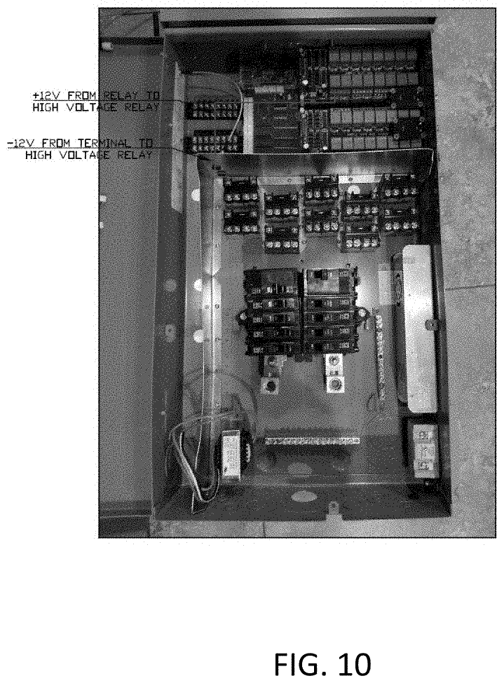

As seen in FIG. 10, a high voltage relay to low voltage relay connection may be formed. It is contemplated that 12 volt power from the low voltage relay may be used to control (on/off) the high voltage relay. Power exits terminal on low voltage relay to mate with the terminal on high voltage relay.

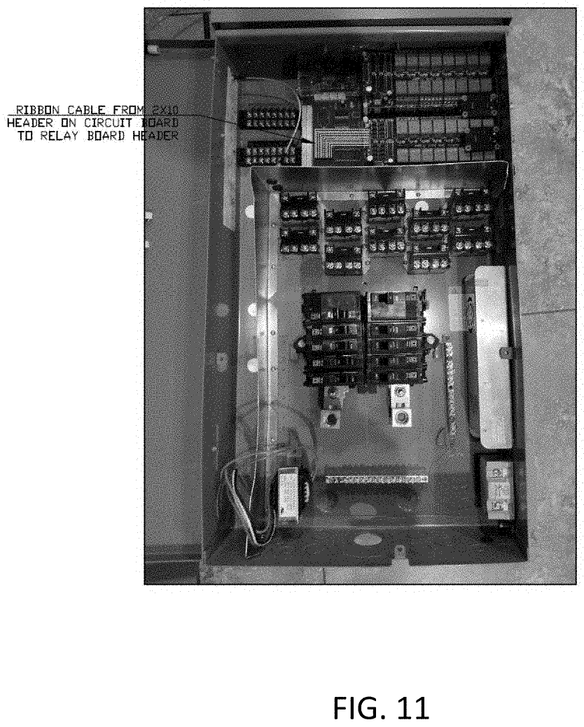

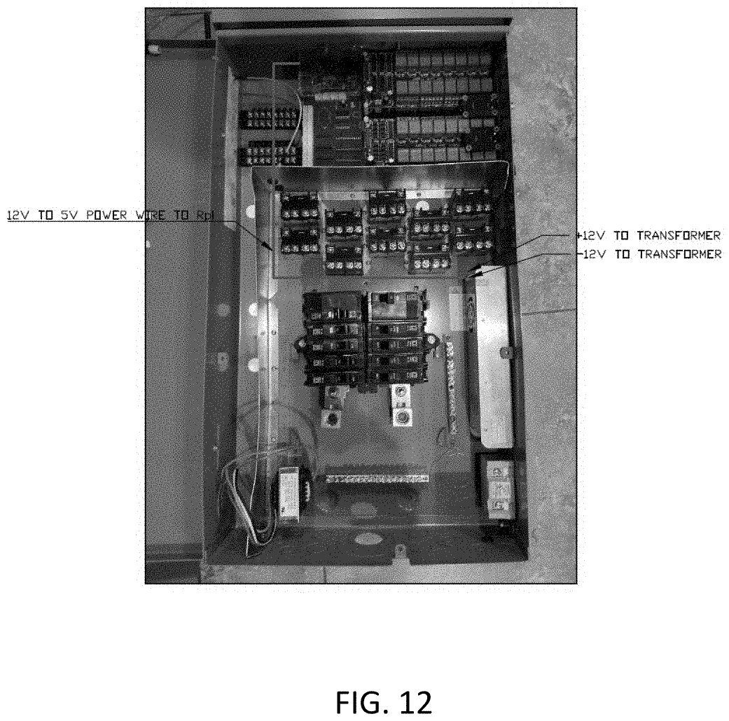

As seen in FIGS. 11 and 12, a connection is made between the headers on the circuit board to the relay board header. Preferably, a ribbon cable is used. Preferably, power is provided to local processor from the 5 volt transformer, wherein 12 volts from 12V transformer provides direct current and then transformed into a 5 voltage direct current to power local processor.

With reference to communication protocols used in an embodiment of the present invention, analog sensors at remote systems provide a 0-5 volt data signal that travels from the sensor to a chip on the circuit board, such as the MCP3007. The chip then directs such analog signal to the local processor, such as a Raspberry Pi. The local processor periodically (e.g. every ten seconds) gathers data from sensor inputs connected to the printed circuit board. The local processor may convert analog or digital signals to a specific numerical value, or otherwise transform the signal into useful information, based on the sensor type and pre-specified conversion tables contained in preprogrammed software housed and run on the local processor. Alternatively, raw data or minor process data may be transferred to the remote server. Data is then transferred from the Raspberry Pi (which creates a display for user interface) to the remote server to allow for the remote server to collect, manage, and archive such data.

Similarly, digital sensor data is handled. Signals travel from the sensor to the printed circuit board. Again, the local processor periodically gathers data from sensor inputs connected to the printed circuit board. The local processor converts the digital signal data into a numeric value, or other useful information, based on sensor type and conversion tables in software. Again, such signals are communicated to the remote server.

The local processor provides for a software interface, wherein a user may access the remote server remotely over network, such as the Internet, wherein the remote server provides access to local processor which communicates information to populate software on the user's local system, or otherwise provide the software to populate and create the local user interface. From the graphical user interface, the user can toggle onto exclusive channels for their specific system. The user can toggle through various channels related to each of the separate remote systems at their control panel location. The information is processed via the chip on the printed circuit board (e.g. a MCP23017 chip). Data transferred from GUI is communicated to local processor to allow the local processor to send commands to a PCB mounted chip, such as the MCP23017, using a protocol, such as I2C. Each of the chips on the printed circuit board is individually addressed and each chip contains a number of outputs for each relay. Thereby, the local processor can cause a relay to be executed from a chip related to one or more of the remote systems. Based on this individual addressing system, one or more, preferably four chips, on the printed circuit board control handling multiple relay boards can manage the entirety of the system wherein the local processor can execute commands from the remote user to power, or otherwise control remote systems.

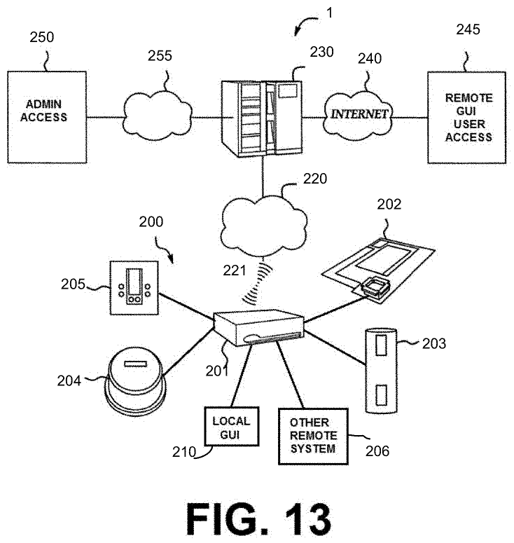

FIG. 13 illustrates the local and remote systems, as well as the network connected remote server and accessed by remote users and admin users. As seen in FIG. 13, local panel 201 includes the local processor. Panel 201 may be coupled to one or more remote systems, such as pool 202, heater 203, gauge 204, irrigation system 205, and other remote system 206. Each of the remote systems is preferably remote devices controlled, powered, or otherwise managed by local processor on panel 201. A local graphical user interface 210 may be provided whereby a user may access software controls via local panel when on-site. Local panel includes processor which is in communication with the network 220 preferably via wireless connection 221. Alternatively, local processor maybe hardwire connected through a network to the greater network. Remote server 230 is preferably in communication with the local server processor to provide for remote processing. In this manner, details about the location site can be communicated to a central processor. From the remote server, a user may access the remote server via the Internet 240 via a graphical user interface 245 hosted on local processor. In this way, the user may access and communicate with the local processor remotely. Thereby, the user may remotely access the local processor to manage remote devices, or remote systems, that are located on-site. Additionally, administrative access may be provided 250 via a back end connection 255.

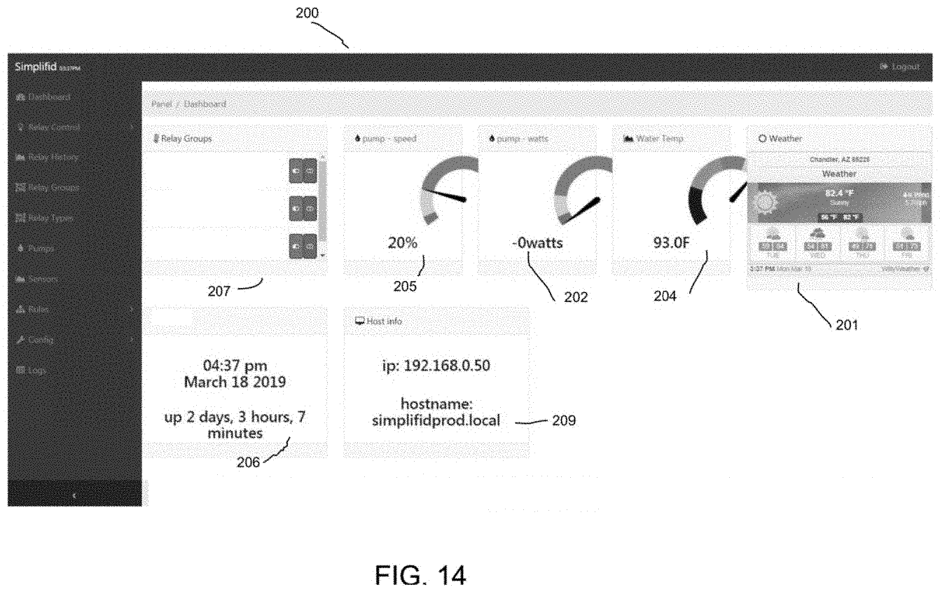

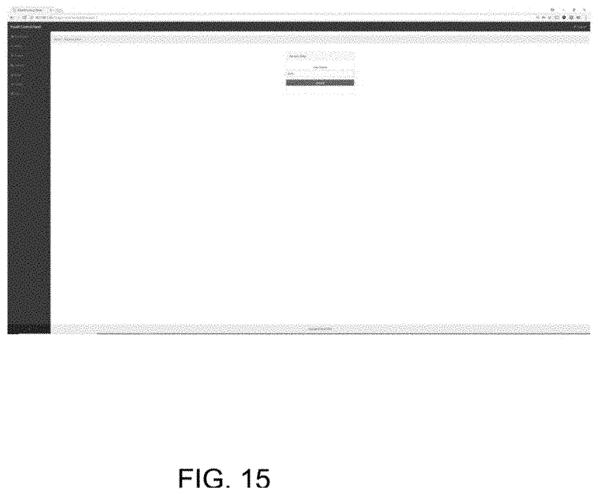

Referring now to FIGS. 14-22, the present invention utilizes a graphical user interface, such as a webpage, to allow for monitoring, maintaining, and controlling various remote systems over a larger network to a remote server. The remote server relays information to the local server, preferably with at least a portion of the signal transmitted via wireless. However, the signal may be hardwired from the greater network to the local processor. A user can log into the system to view the status of varied remote systems, as well as location data. For instance, local weather conditions can be shown as seen in FIG. 14, panel 200 item 201. Further information regarding temperature of items on location based on sensor input can be seen as shown in FIG. 14, 200, power outputs 202, water temperature 204. pump speed, 205, Time/Date 206, Group info 207, Host/IP 209, etc. As seen in FIG. 15. remote access may be secured to prevent unauthorized access to information and/or control of the system. A security feature may be implemented to limit access to local processor, such as limiting access to only on one or more GUI IP address.

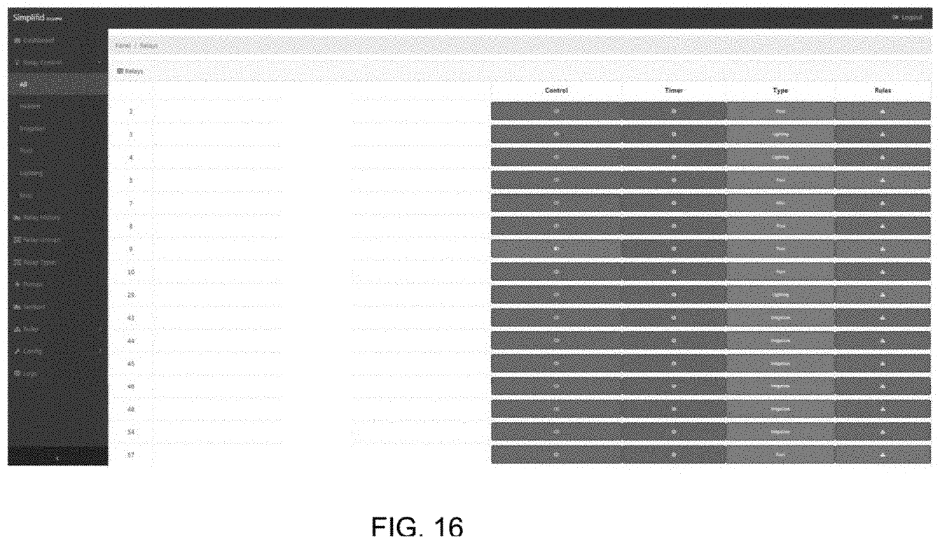

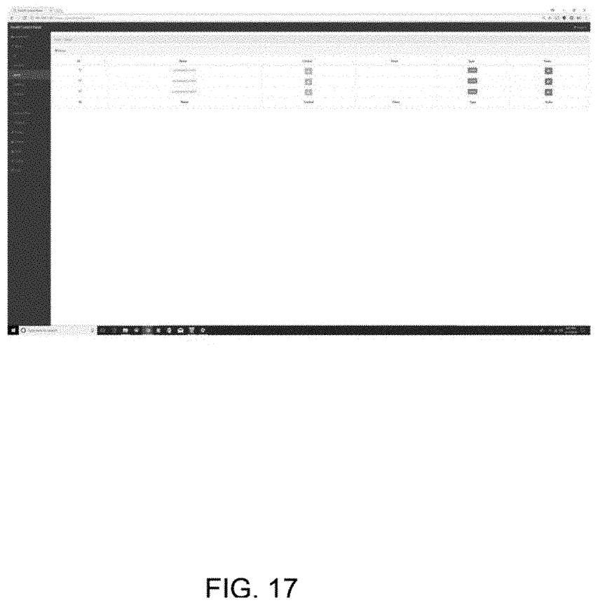

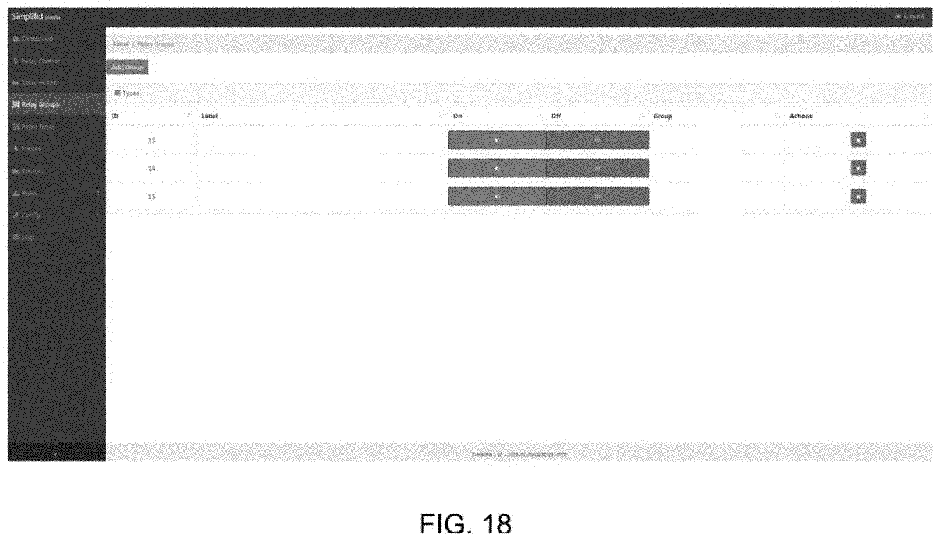

As seen in FIG. 16, all available relays may be displayed in a list with controls provided. On the display as shown in FIG. 16, relay ID, relay name, and control toggle red or green, timers, relay type, and rules, may all be used to access each of the relays. Relays may here be turned on and off, and otherwise rules may be programmed via the remote user over the network. For instance, a remote system may be turned on for a set length of time or manually shut off. Moving into further relay systems as seen in FIGS. 17 and 18, subsystems, each devoted to a separate remote system, may be accessed and controlled thereby. Selections of items, such as the light color of a specific light display can be altered and modified through this remote system.

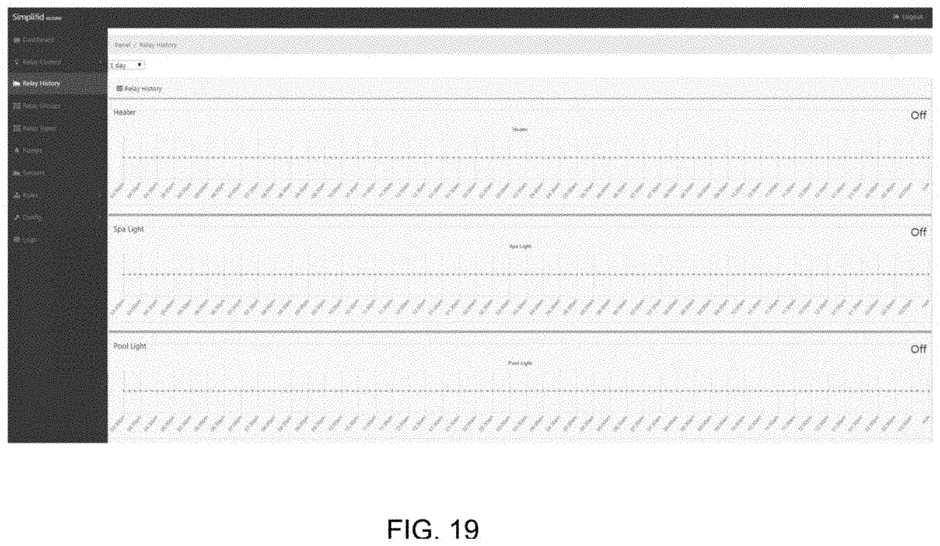

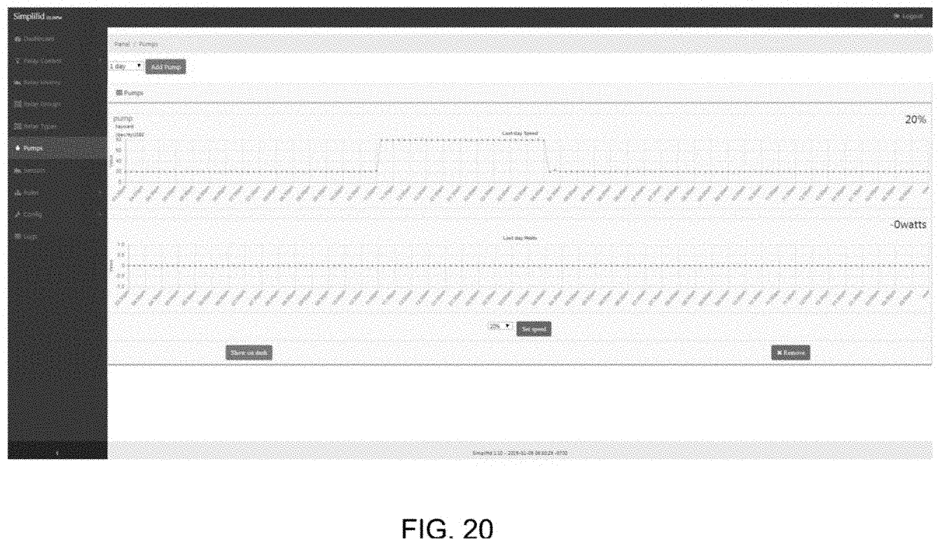

As can be seen in FIG. 18, data related to one or more remote systems may be displayed as information via the web browser. By viewing charts, such as FIG. 19, the user can select specific programs (pump) as shown in FIG. 20 based on prior information, and use this information to schedule future events and/or rules. User may use a pulldown menu to select a specific attribute, such as speed, and set a program button to send a command to the remote device.

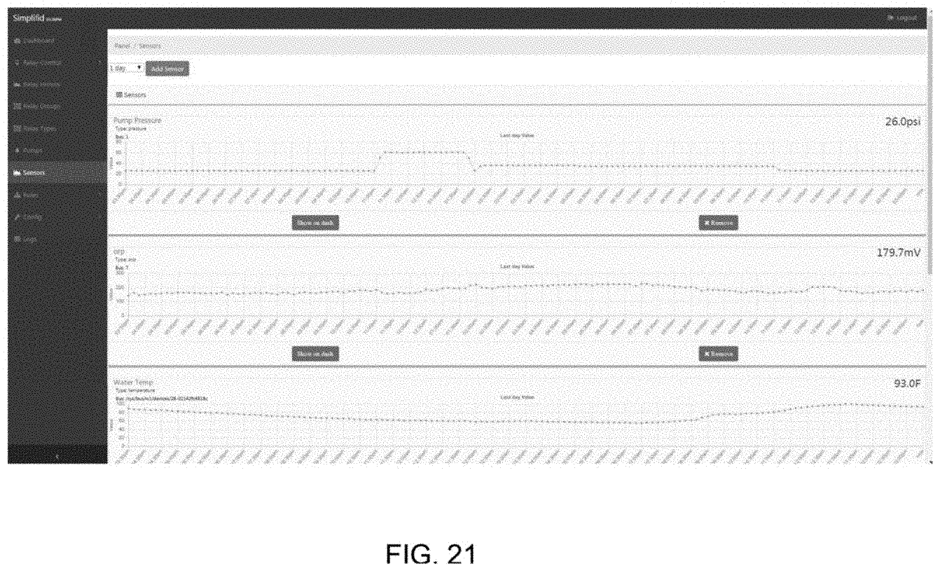

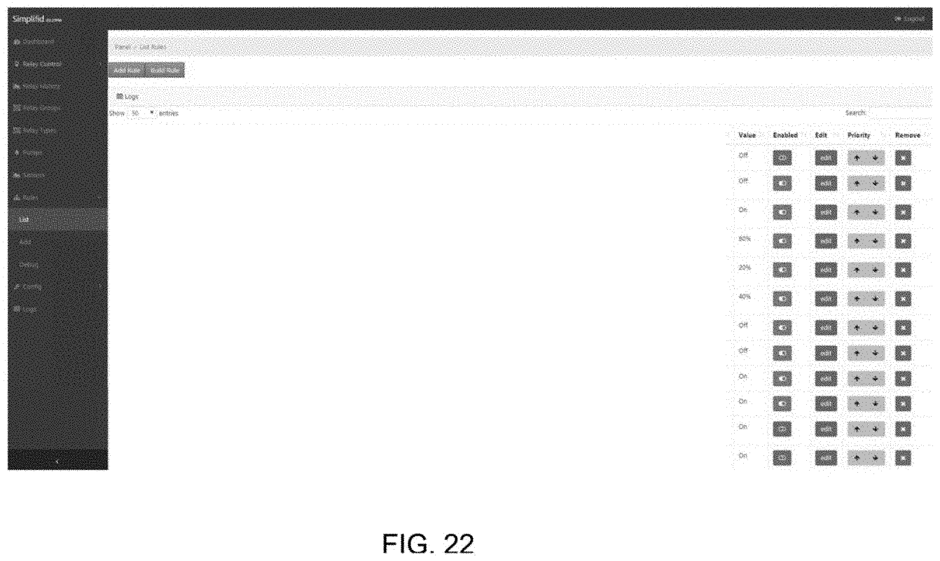

Further, specific information to each of the remote systems, or remote devices maybe shown. User may remotely add or program new remote systems whether or not such remote systems are as of yet connected to the local panel. User can manage each of the remote devices, such as by giving them names and programming the use of such remote devices. FIG. 21 demonstrates a histograph of (pump pressure, etc.) sensor data, and sensor function for a variety of sensors coupled to local processor. As seen in FIG. 22, display may demonstrate the priority of various rules of potentially conflicting remote devices. For instance, if the total power required to be supplied through panel exceeds a certain threshold, or one or more relay is otherwise unavailable, specific priority rules may be employed. Alternatively, if different actions may override one another, such as watering a plant at the same time as watering the law n, priority rules may be provided to ensure proper pressure supplied to watering. Furthermore, notifications may be programmed to be sent to user based on specific input from one or more remote system.

Notifications may be set and priority rules established. Rules may include scheduling, sensor input, and rules may set action depending on other rules (such as a pool heater requiring a pool pump to be run at maximum/full speed, or a pressure vacuum reading of something caught in return would release the pump (turn oft), etc.). The local processor may also periodically ping remote device(s) to interact with a processor on a remote device, or otherwise sense status, for information such as wattage supplied, revolutions per mute, usage, powder status. In this way the local processor can send an “ask” signal and get a response for remote device. If pin g indicates an anomaly, local processor may be empowered to reboot a remote device, e.g. if local processor loses connection to a remote device for thirty seconds, local processor can initiate reboot to trip power source for reboot. Additionally, if local processor identifies a malfunctioning remote device, such information can be relayed to the user. For instance, if pump is shown to be powered (on) at local processor, but pressure reads 0-null, many faults in remote device (pump and plumbing) may be indicated. In one exemplary case, a pump may be running on air (lack of vacuum due to failure to prime pump). A rule may be initiated wherein a valve is opened to supply water through a tune to prime pump, thereafter, when water flow through priming tube decreases (due to full pump), the pump can then be re-started. Similarly, the system can read the amount of water flowing into a system (such a pool refill) and chart the averages based on input of local weather conditions to determine a leak (should excessive water be required to refill pool). Notifications may be sent by text, email, or otherwise. In addition, the system is preferably programmed to handle multiple software languages or remote devices of varied manufacturers.

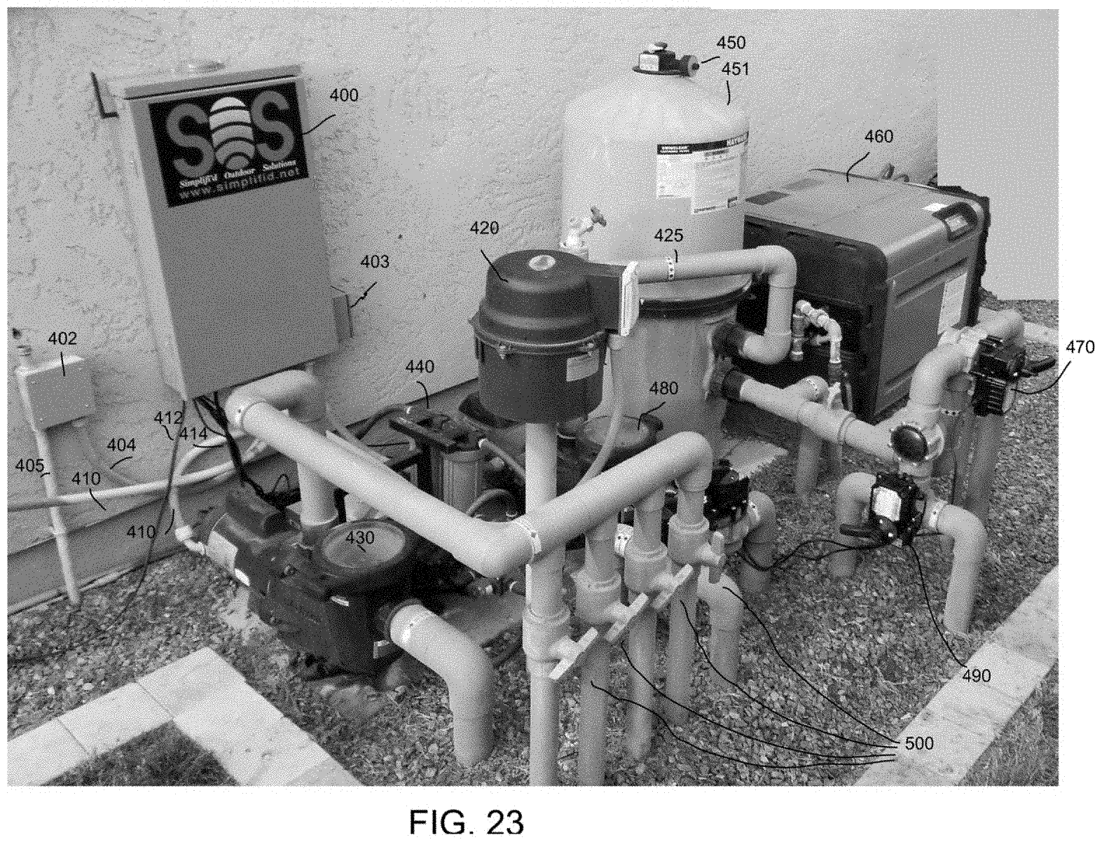

As seen in FIG. 23, an alternative system is shown. Control panel 400 includes an incoming power supply 404 from a power source 405 via powder junction 402. Control panel 400 includes optional GFCI outlet 403 providing 110 volts power. High voltage power lines 410 provide high voltage (e.g. 220V AC) to waterfall pump 430, mist pump 440, air blower 420, gas heater 460 (controlled via control panel for on/off switching, or lighting pilot), filter pump 480, etc. Lower voltage power supply may be required for other devices. pH sensors, or other sensors 425 may be placed along plumbing of remote systems. Remote devices in system may be connected to panel 400 via lead lines 414, and sensors may be monitored via wireless or wired 412 connection. For instance, a wireless pressure sensor 450, of the filter canister 451, may provide wireless data to an adapter connected to PCB (not shown). Valves 470 and 490 of an automatic valve controller may be actuated by system along lines 414. Additionally, manual valves 500 may be integrated with system. Local panel 400 incudes a local processor (such as a min processor, aka Raspberry Pi) (not shown) that can coordinate various functions to allow proper use of all coupled devices. For instance, should a fountain feature be requested, a set of programed events may initiate with a first function (e.g. pump), followed by a second function (e.g. valve) at a slight delay.

We hereby claim:

1. A control panel system adapted for monitoring, reporting, and controlling a multitude of systems via a computerized and electronic system, said control panel comprising:
a. a housing enclosing a main processor, relays, signal receivers, and signal converters adapted to modify analog signal to digital:
b. said main processor comprising software for the instruction to electronically coupled remote systems, said systems including at least one of irrigation, electrical, security, pool, heating, misting, and landscaping, irrigation, or similar:
c. a network communication sub-system in communication with said main processor, the network communication subsystem (i) establishing a network connection between the main processor and at least one of said remote systems, (ii) providing for remote monitoring of operational parameters associated with the at least one remote system, from the at least one remote system over the network connection in both analog and digital formats: and (iii) providing for remote control of the at least one remote system from the main processor over the network connection.

2. The control panel as set forth in claim 1 further comprising: a wireless adapter sending outgoing wireless signals from the local processor to an outboard computer, said outgoing wireless signals comprising information regarding the status of the remote systems and processor-generated past events and processor-generated schedule for future events.

3. The control panel as set forth in claim 2 wherein said wireless adapter adapted to receive incoming wireless signals, said wireless adaptor transmitting said incoming wireless signals to said main processor, said main processor storing said incoming signal in temporary memory, and said main processor modifying main processor generated schedule for future events based on said incoming wireless signals.

4. The control panel as set forth in claim 3, wherein said incoming wireless signals may include software upgrades adapted to load into main processor memory; shut down and restart main processor to update said main processor software.

5. The control panel as set forth in claim 1 further comprising an alternating current power receiver, and transformers to provide both alternating current and direct current to said remote systems via a system of power supplies, each of said power supplies directed to one or more of said remote systems to power and control said remote systems.

6. The control panel as set forth in claim 5 wherein said power supply is accompanied by a digital and/or analog signal to said remote system; said digital and/or analog signal provided along with said power supply.

7. The control panel as set forth in claim 5 comprising a 12 VDC transformer adapted to convert incoming alternative power from said power receiver to 12-volt direct current.

8. The control panel as set forth in claim 7 further comprising a 5 VDC transformer adapted to convert processed 12-volt direct current to 5-volt direct current for supply to said main processor

9. The control panel as set forth in claim 5 comprising a transformer adapted to modify incoming voltage to a new useful outgoing voltage for supply to at least one remote system.

10. The control panel as set forth in claim 5 wherein said power receiver comprising a grounded 125-volt GFCI with automatic internal testing, and adapted to detect trips on actual ground faults during or self-testing.

11. The control panel as set forth in claim 1 further comprising a multi-pinned high-voltage relay receiving low voltage power, said high-voltage relay providing high-voltage for managing high voltage power supplies to said remote systems.

12. The control panel as set forth in claim 11 further comprising a low-voltage relay board equipped with a high-current relay.

13. The control panel as set forth in claim 1 wherein said main processor comprises a Raspberry Pi.

14. The control panel as set forth in claim 13 wherein said Raspberry Pi computes a preprogrammed software algorithm on an entry input in an analog signal from a remote system.

15. The control panel as set forth in claim 14 wherein said remote system utilizes a soil moisture sensor to provide said entry input.

16. The control panel as set forth in claim 14 wherein said remote system utilizes a vacuum sensor to provide said entry input.

17. The control panel as set forth in claim 14 wherein said remote system utilizes a pressure sensor to provide said entry input.

18. The control panel as set forth in claim 14 wherein said remote system utilizes an oxidation reduction potential sensor to provide said entry input.

19. The control panel as set forth in claim 14 wherein said remote system utilizes a pH sensor to provide said entry input.

20. The control panel as set forth in claim 14 wherein said remote system utilizes a total-dissolved-solids sensor to provide said entry input.

21. The control panel as set forth in claim 13 wherein said Raspberry Pi computes a preprogrammed software algorithm on an entry input in digital signal from a remote system.

22. The control panel as set forth in claim 21 wherein said remote system utilizes a temperature sensor to provide said entry input.

23. A method for remotely monitoring and controlling at least one remote system, comprising the steps of:
a. assigning a location of a remote system in a local processor;
b. establishing a network connection between the remote processor and the local processor;
c. providing for remote monitoring of operational parameters associated with the remote system from the local processor over the network connection; and
d. providing for remote control of the remote system from the local processor over the network connection.
e. wherein the local processor is coupled to at least one control board, said local processor providing both signals to control the remote system and power supply, the power supply provided in both alternating and direct current to one or more remote systems.

24. The method of claim 23 wherein the local processor processes a software program managing more than one remote system in at least two separate programming languages.

25. The method of claim 23 further comprising the step of determining by the local processor whether line power is being supplied to a remote system.

26. The method of claim 23 further comprising calculating a programmed schedule of managing a remote system; providing power and input to the remote system; and activating the remote system according to the preprogrammed algorithm.

27. The method of claim 26, further comprising receiving at the local processor operational data from a remote system sensor and determining by the processor if further action is required; and taking necessary action of turning on, turning off, or modifying the rate of power supply, to the remote system.

28. The method of claim 27 further comprising the step of sending a signal via a wireless transmitter coupled to the local processor to a remote processor, the signal including information from a multitude of sensors from a multitude of remote systems, and the local processor hosting a generated webpage for displaying the information in a graphical user interface.

29. The method of claim 2S further comprising the step of a user modifying a programmed schedule via the graphical user interface, transmitting commands to the local processor, and the local processor amending the programmed schedule in accordance to commands received.
